(19) United States
(12) Patent Application Publication
(10) Pub. No.: US 2021/0277675 A1
(43) Pub. Date: Sep. 9, 2021

(54) Surface Concealment System

(71) Applicant: Daniel Logan Daley, Fort Collins, CO (US)

(72) Inventor: Daniel Logan Daley, Fort Collins, CO (US)

(21) Appl. No.: 16/809,675

(22) Filed: Mar. 5, 2020

(51) Int. Cl. E04G 23/02; B32B 15/08; B32B 7/12; B32B 7/06; B32B 15/18; E04F 13/04

(52) U.S. Cl. CPC E04G 23/0214; B32B 15/08; B32B 7/12; B32B 7/06; B32B 2556/00; E04F 13/042; B32B 2250/42; B32B 2250/44; B32B 2405/00; B32B 15/18

(57) ABSTRACT

A multi-layered surface indentation concealment system having a body including a medial portion and a flexible peripheral margin extending outward of said medial portion. The body can be disposed to conceal a surface indentation in a surface, whereby the medial portion spans the surface indentation and the flexible peripheral margin secures about the surface indentation by application of a coat composition to the flexible peripheral margin.

### I. FIELD OF THE INVENTION

A multi-layered surface indentation concealment system having a body including a plurality of superimposed layers which from outer layer to inner layer successively cover a lesser width of the body. The body can be disposed to conceal a surface indentation in a surface, whereby the body spans the surface indentation and the outermost layer peripheral margin can be secured about the surface indentation by application of a coat composition to the outermost layer peripheral margin.

### II. SUMMARY OF THE INVENTION

Accordingly a broad object of the present invention is to provide an apparatus including a body including two or more superimposed layers which from outer layer to inner layer successively cover a lesser width of said body, the plurality of superimposed layers including, from outer layer to inner layer, a first layer comprising a stainless steel, a second layer comprising an adhesive, a third layer comprising a stainless steel, and a fourth layer comprising an adhesive.

Another broad object of the present invention is to provide a method including one or more of adhering a body on a surface, where the body includes two or more of a plurality of superimposed layers which from outer layer to inner layer successively cover a lesser width of the elongate body, the plurality of superimposed layers including, from outer layer to inner layer, a first layer comprising a stainless steel, a second layer comprising an adhesive, a third layer comprising a stainless steel, and a fourth layer comprising an adhesive, the adhesive of the fourth layer adhering the body to the surface.

### III. BRIEF DESCRIPTION OF THE DRAWINGS

FIG. 1 is an illustration of a method of concealing a surface indentation using an embodiment of a multi-layered surface indentation concealment system.

FIG. 2 is cross section view 2-2 shown in FIG. 1 which shows an embodiment of a multi-layered surface indentation concealment system spanning a surface indentation and a outermost layer peripheral margin of a body flexed (shown in broken line) for application of a coat composition to the surface surrounding the surface indentation and the outermost layer peripheral margin secured to the surface about the surface indentation (shown in solid line) by the coat composition.

FIG. 3 is a top plan view of a particular embodiment of a multi-layered surface indentation concealment system.

FIG. 4 is a bottom plan view of a particular embodiment of a multi-layered surface indentation concealment system having a peelable layer removed to view a plurality of superimposed layers of the body of the multi-layered surface indentation concealment system.

FIG. 5 is a front elevation view of a particular embodiment of a multi-layered surface indentation concealment system.

FIG. 6 is an enlarged portion of the front elevation view of FIG. 5 including a key identifying each of the plurality of superimposed layers of the multi-layered surface indentation concealment system.

FIG. 7 illustrates a particular embodiment of the multi-layered surface indentation concealment system wound in a roll from which a length can be excised.

### IV. DETAILED DESCRIPTION OF THE INVENTION

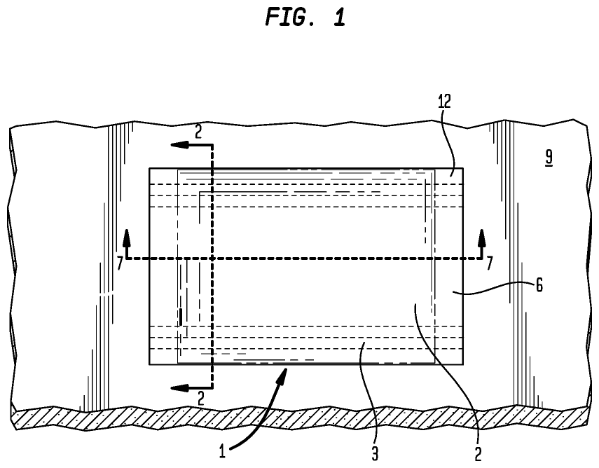

Generally, referring to FIGS. 1 through 6, a multi-layered surface indentation concealment system (1) having a body (2) including a plurality of superimposed layers (3) alternating between stainless steel layers (4) and adhesive layers (5), which from outer layer (6) to inner layer (7) successively cover a lesser width (8) of the body (2).

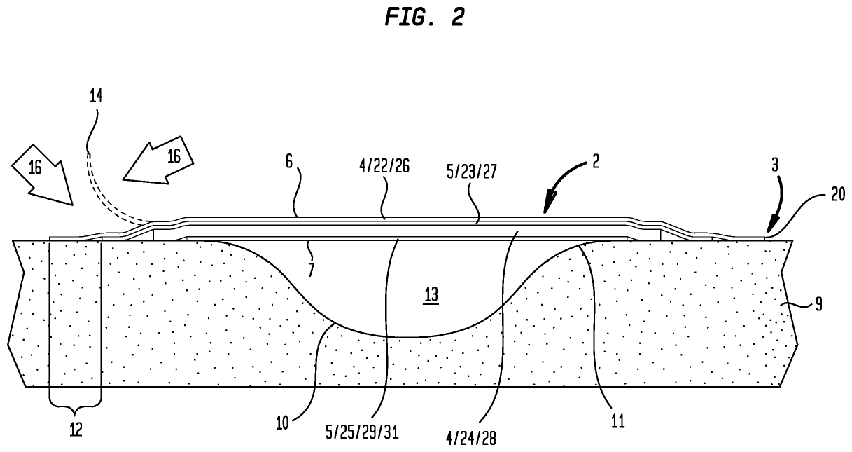

Now referring primarily to FIGS. 1 and 2, particular methods of using embodiments of the body (2) can include disposing the body (2) on a surface (9). The surface (9) can, but need not necessarily, include a cavity (10) extending to a cavity rim (11). For the purposes of this invention the term “cavity” means an unfilled space, and without limitation to the breadth of the foregoing, an unfilled space can include as illustrative examples the gap between affixed wall panels or drywall panels, holes penetrating a wall panel or drywall panel, surface gouges, indentations, recesses, hollows, pockets, pouches, apertures, pits, or the like.

Again, referring to FIGS. 1 and 2, in particular methods of using embodiments, the body (2) can be disposed over the cavity (10) with the outermost layer peripheral margin (12) disposed over the surface (9) around the cavity rim (11). In particular methods, the body (2) can span or bridge the cavity (10) with the outermost layer peripheral margin (12) secured about the cavity rim (11) defining the cavity (10). In this manner, the body (2) spans the unfilled space (13) but does not necessarily fill the unfilled space (13) of the cavity (10). In particular embodiments, the body can fill a portion or all of the cavity (10). In particular embodiments, the outermost layer peripheral margin (12) can be flexed outward from the surface (9) (as shown in the example of FIG. 2 in broken line). The portion (14) of the surface (9) located beneath the retracted outermost layer peripheral margin (12) can, but need not necessarily, have a first layer (15) of coat composition (16) applied to the surface (9) around the cavity (10) or the surface (9) of the outermost layer peripheral margin (12) facing the surface (9), or both. The outermost layer peripheral margin (12) facing the surface (9) can be forcibly urged against the surface (9) with the first layer (15) of coat composition (16) disposed between the outermost layer peripheral margin (12) and the surface (9) around the cavity (10). Forcible urging can be applied to the outermost layer peripheral margin (12) by use of a hand or with a tool such as a squeegee, roller, sponge, trowel, knife, scraper, chisel, or other like tool which can be contacted to and moved across the outermost layer peripheral margin (12) engaged to the first layer (15) of coat composition (16) to promote adhesion of the outermost layer peripheral margin (12) to the coated surface (9) around the cavity (10). The first layer (15) of coat composition (16) can, but need not necessarily, be permitted to cure or dry. In particular methods, a second layer (17) of coat composition (16) can be disposed on the outward facing surface (18) of the outermost layer peripheral margin (12) or body (2). In further particular methods, the second layer (17) of coat composition (16) can extend outward a distance from the outermost layer peripheral margin (12) of the body (2). The second layer (17) of coat composition (16) can, but need not necessarily, be permitted to cure or dry.

The term “coat composition” broadly includes any composition compatible with and which can be applied to the surface (9) having the cavity (10) and the body (2), which coat composition (16) permitted to cure or dry can secure the outermost layer peripheral margin (12) of the body (2) to the surface (9) to conceal the cavity (10) and without limitation to the breadth of the foregoing includes as illustrative examples one or more of: a preparatory coating to seal dry wall panels, drywall surface primer, primer as a preparatory coating before painting, acrylic primer, vinyl acrylic primer, enamel primer, vinyl acetate emulsion, latex paint, enamel paint, or like compositions. As an illustrative example, the first layer (15) of coat composition (16) can be a primer and the second layer (17) of coat composition (16) can be paint.

Now referring primarily to FIG. 2, in particular embodiments in which the body (2) further includes an adhesive layer (5) as an innermost layer (19), the method can further include forcible urging on the body (2), as above described, to adhere the adhesive layer (5) to the surface (9) to secure the body (2) to span the cavity (10) in the surface (9). A coat composition (16) can be applied to the surface (9) or to the outermost layer peripheral margin (12) to secure the outermost layer peripheral margin (12) to the surface (9). The adhesive layer (5) material can be selected from the group consisting of: two-sided tape, one-sided tape, latex-based adhesive, synthetic elastomeric polymer adhesive, and polyvinyl acetate adhesive, or combinations thereof.

Embodiments of the method can confer a substantial advantage in that the outermost layer peripheral margin (12) of the body (2) can be sufficiently thin that upon securement with a coat composition (16) to the surface (9) or by further application of the coat composition (16) over the outermost layer peripheral margin (12), the body (2) or the surface (9) may not require any further treatment to conceal the cavity (10) in the surface (9) or conceal the body (2) in relation to the surface (9). The surface (9) having the body (2) affixed by the method can further receive conventional texture or paint products.

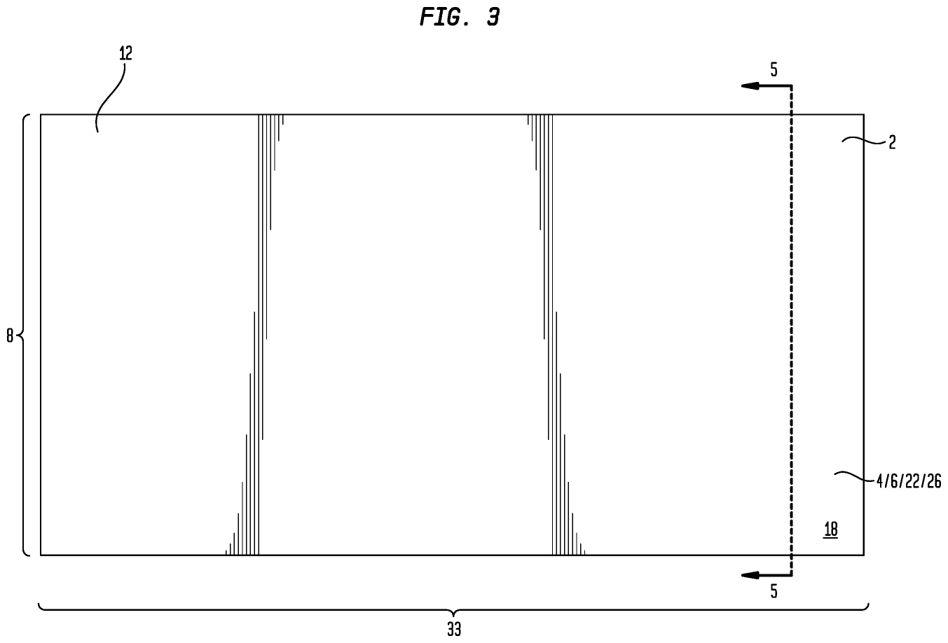

Now, referring primarily to FIGS. 3 through 6, in particular embodiments, the body (2) can be produced as a plurality of superimposed layers (3). The plurality of superimposed layers (3) from the outer layer (6) to the inner layer (7) can successively cover a lesser width (8) of the body (2). In particular embodiments, the peripheral margin (20) of each of the plurality of superimposed layers (3) can remain uncovered.

Now, referring to FIGS. 3 through 6, in particular embodiments, the plurality of superimposed layers (3) can include a plurality of alternating stainless steel layers (4) and adhesive layers (5). In particular embodiments, the alternating stainless steel layers (4) and adhesive layers (5) of the body (21) can have combined thickness (21) in which the layers alternate between a stainless steel layer (4) as the outer layer (6) to an adhesive layer (5) as the inner layer (7). In particular embodiments, the stainless steel layers (4) can comprise stainless steel, ferritic stainless steel, austenitic stainless steel, martensitic stainless steel, duplex stainless steel, precipitation hardening stainless steel, or other like composite stainless steels, or combinations thereof. However, depending on the application, the stainless steel layer can, but need not necessarily, be substituted with layers of aluminum, copper, nickel, tin, brass or iron and combinations thereof. The adhesive material of the adhesive layers (5) can be two-sided tape, one-sided tape, latex-based adhesive, synthetic elastomeric polymer adhesive, and polyvinyl acetate adhesive, or combinations thereof.

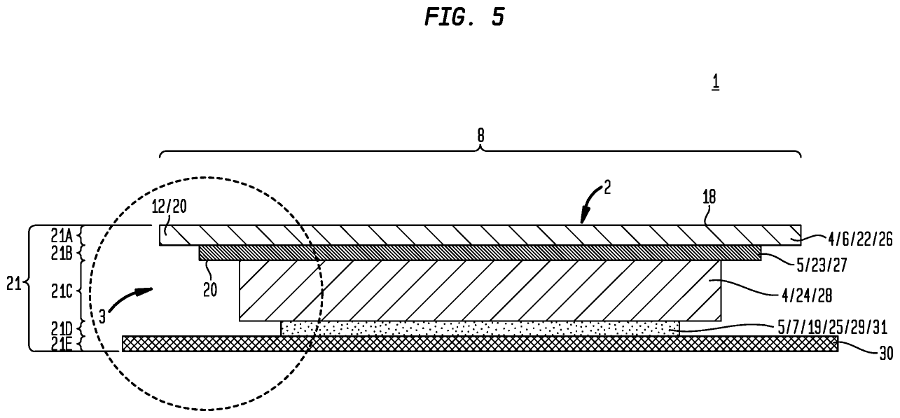

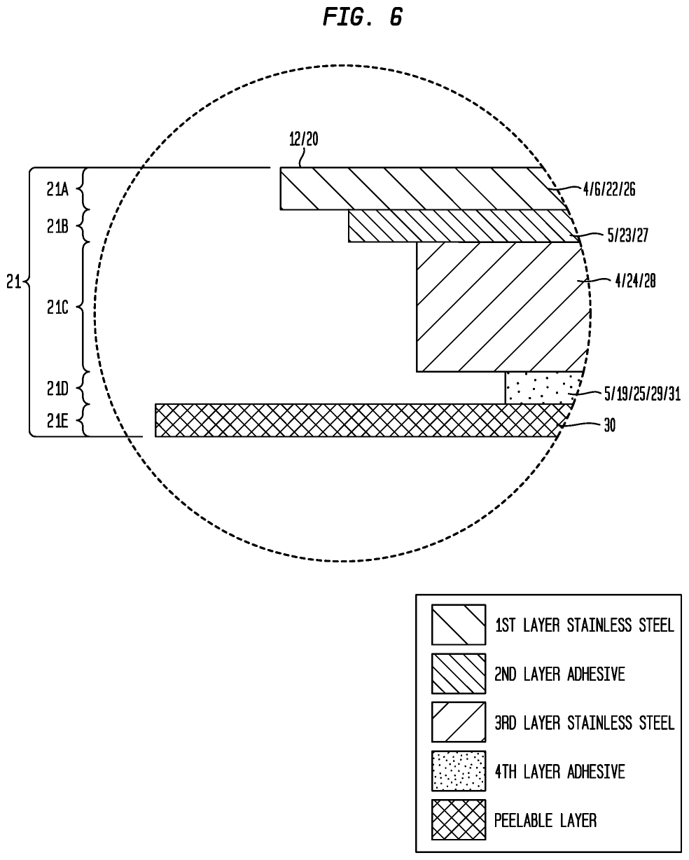

Now, referring to FIGS. 5 and 6, in particular embodiments, and as an illustrative example, the plurality of superimposed layers (3) can include a first layer (22) (outer layer (6)), a second layer (23), a third layer (24), and a fourth layer (25). The first layer (22) can be a first stainless steel layer (26). The first stainless steel layer (26) can have a thickness (21A) occurring in the range of about 0.015 mm and about 0.035 mm; although in particular applications, the thickness (21A) could be lesser 0.015 mm or greater than 0.035 mm. In particular embodiments, the first stainless steel layer (26) can have a thickness (21A) selected from the group consisting of: about 0.016 mm to about 0.018 mm, about 0.017 mm to about 0.019 mm, about 0.018 mm to about 0.020 mm, about 0.019 mm to about 0.021 mm, about 0.020 mm to about 0.022 mm, about 0.021 mm to about 0.023 mm, about 0.022 mm to about 0.024 mm, about 0.023 mm to about 0.025 mm, about 0.024 mm to about 0.026 mm, about 0.025 mm to about 0.027 mm, about 0.026 mm to about 0.028 mm, about 0.027 mm to about 0.029 mm, about 0.028 mm to about 0.030 mm, about 0.029 mm to about 0.031 mm, about 0.030 mm to about 0.032 mm, about 0.031 mm to about 0.033 mm, about 0.032 mm to about 0.034 mm, or combinations thereof.

The first stainless still layer (26) can further include a width (8) that can occur in a range of about 25 mm to about 80 mm; although depending on the application the width (8) of the first layer (22) can have a width (8) of lesser than 25 mm or greater than 80 mm. In particular embodiments, the width (8) can be selected from the group consisting of: about 26 mm to about 35 mm, about 30 mm to about 40 mm, about 35 mm to about 45 mm, about 40 mm to about 50 mm, about 45 mm to about 55 mm, about 50 mm to about 60 mm, about 55 mm to about 65 mm, about 60 mm to about 70 mm, about 65 mm to about 75 mm, about 70 mm to about 79 mm, or combinations thereof.

In particular embodiments, the second layer (23) can be a first adhesive layer (27) coupled to the first layer (22). The first adhesive layer (27) can have a thickness (21B) occurring in a range of about 0.01 mm to about 0.05 mm; although depending on the application the thickness (21B) of the first adhesive layer (27) can be less than 0.01 mm or greater than 0.05 mm. In particular embodiments, the thickness (21B) of the first adhesive layer (27) can be selected from the group consisting of: about 0.02 mm to about 0.03 mm, about 0.025 mm to about 0.035 mm, about 0.030 mm to about 0.040 mm, and about 0.035 mm to about 0.045 mm, or combinations thereof.

In particular embodiments, the third layer (24) can be a second stainless steel layer (28) coupled to the second layer (23). The second stainless steel layer (28) can have a thickness (21C) that can occur in a range of about 0.05 mm to about 1.0 mm; although depending on the application the thickness (21C) of the second stainless steel layer (28) can be less than 0.05 mm or greater than 1.0 mm. In particular embodiments, the thickness (21C) can be selected from the group consisting of: about 0.04 mm to about 0.06 mm, about 0.05 mm to about 0.07 mm, about 0.06 mm to about 0.08 mm, about 0.07 mm to about 0.09 mm, about 0.08 mm to about 0.095 mm, or combinations thereof.

In particular embodiments, the fourth layer (25) can be a second adhesive layer (29) coupled to the third layer (24). The fourth layer (25) can have a thickness (21D) that occurs in a range of about 0.01 mm and about 0.05 mm; although depending on the application the thickness (21D) of the second adhesive layer (29) can be lesser than 0.01 mm or greater than 0.05 mm. In particular embodiments, the thickness (21D) can be selected from the group consisting of: about 0.02 mm to about 0.03 mm, about 0.025 mm to about 0.035 mm, about 0.03 mm to about 0.04 mm, and about 0.035 mm to about 0.045 mm, or combinations thereof. The preceding description of this illustrative embodiment is not meant to preclude or obviate other embodiments of the body above described.

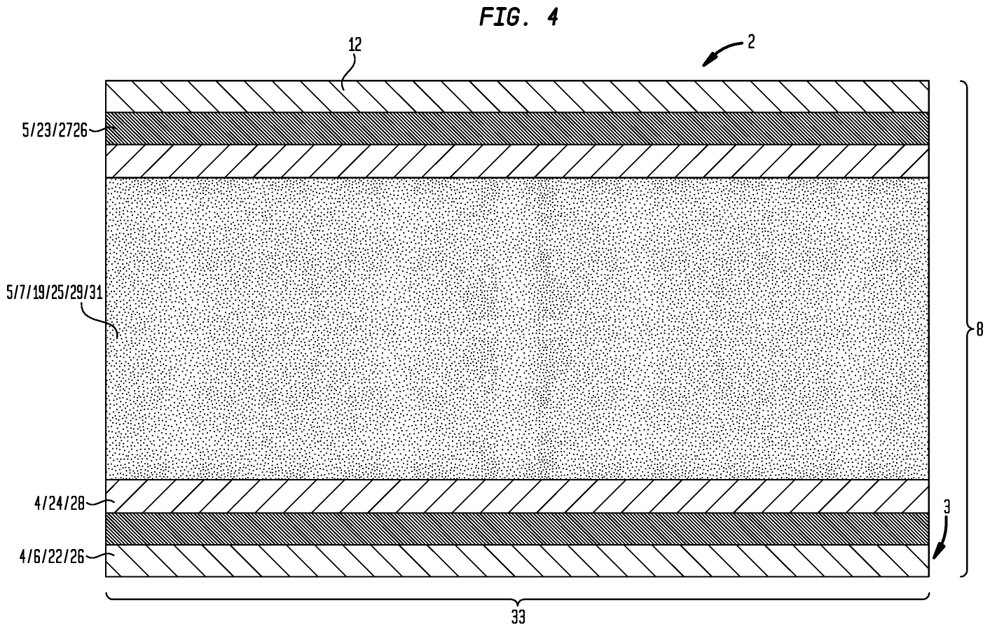

Now referring to FIGS. 4 through 6, in particular embodiments, a peelable layer (30) can, but need not necessarily, be engaged to the innermost adhesive layer (31). The peelable layer (30) can have a width (8) greater than the first layer (22). In particular embodiments, the peelable layer (30) can have a width (8) greater than or substantially equal to the width (8) of the first adhesive layer (27). The peelable layer (30) can be peelably removed prior to engaging the body (2) over a cavity (10) in the surface (9).

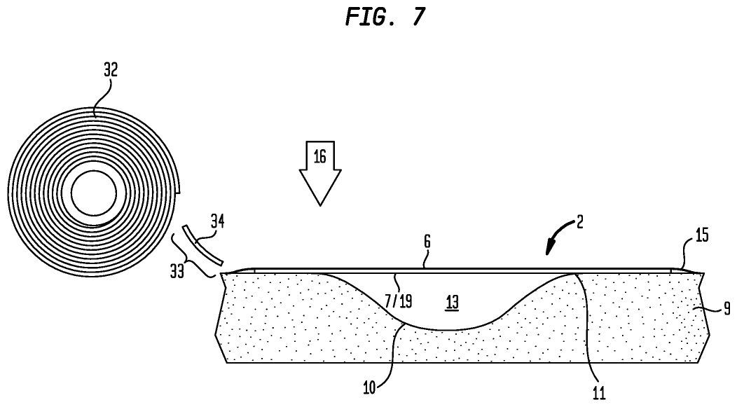

Now referring to FIG. 7, particular embodiments of the body, including a plurality of superimposed layers (3) and including, but not necessarily, a peelable layer (30), can further be wound in rolls (32). In particular methods of using the body (2), the roll (32) can be unwound to a desired length (33), where the unwound portion (34) of the roll (32) spans or bridges the cavity (10) with the outermost layer peripheral margin (12) secured about the cavity rim (11) defining the cavity (10). The unwound portion (34) can then be severed from the roll (32) and applied to the cavity (10), as described previously. In further particular embodiments, the body (2) may already be severed into pre-determined lengths and wound in a roll (32).

As can be easily understood from the foregoing, the basic concepts of the present invention may be embodied in a variety of ways. The invention involves numerous and varied embodiments of a multi-layered surface indentation concealment system and methods for making and using such multi-layered surface indentation concealment system including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “layer” should be understood to encompass disclosure of the act of “layering”—whether explicitly discussed or not—and, conversely, were there effectively disclosure of the act of “layering”, such a disclosure should be understood to encompass disclosure of a “layer” or even a “means for layering.” Such alternative terms for each element or step are to be understood to be explicitly included in the description.

In addition, as to each term used, it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the multi-layered surface indentation system herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. An apparatus, comprising:
a body including a plurality of superimposed layers which from outer layer to inner layer successively cover a lesser width of said body, said plurality of superimposed layers from an outer layer to an inner layer:
a first layer comprising a stainless steel;
a second layer comprising an adhesive;
a third layer comprising a stainless steel; and
a fourth layer comprising an adhesive.

2. The apparatus of claim 1, further comprising a peelable layer superimposed on said fourth layer, said peelable layer having a greater width than said first layer.

3. The apparatus of claim 1, wherein each of said plurality of superimposed layers medially superimposed from said outer layer to said inner layer to successively cover said lesser width of said elongate body, whereby a peripheral margin remains uncovered along each edge of said first layer, said second layer and said third layer.

4. The apparatus of claim 1, wherein said first layer comprising said stainless steel has a thickness occurring in a range of about 0.015 mm to about 0.035 mm.

5. The apparatus of claim 4, wherein said first layer comprising said stainless steel has a thickness selected from the group consisting of: about 0.016 mm to about 0.018 mm, about 0.017 mm to about 0.019 mm, about 0.018 mm to about 0.020 mm, about 0.019 mm to about 0.021 mm, about 0.020 mm to about 0.022 mm, about 0.021 mm to about 0.023 mm, about 0.022 mm to about 0.024 mm, about 0.023 mm to about 0.025 mm, about 0.024 mm to about 0.026 mm, about 0.025 mm to about 0.027 mm, about 0.026 mm to about 0.028 mm, about 0.027 mm to about 0.029 mm, about 0.028 mm to about 0.030 mm, about 0.029 mm to about 0.031 mm, about 0.030 mm to about 0.032 mm, about 0.031 mm to about 0.033 mm, and about 0.032 mm to about 0.034 mm, and combinations thereof.

6. The apparatus of claim 1, wherein said first layer comprising said stainless steel has said width occurring in a range of about 25 mm to about 80 mm.

7. The apparatus of claim 6, wherein said first layer comprising said stainless steel has a width selected from the group consisting of: about 26 mm to about 35 mm, about 30 mm to about 40 mm, about 35 mm to about 45 mm, about 40 mm to about 50 mm, about 45 mm to about 55 mm, about 50 mm to about 60 mm, about 55 mm to about 65 mm, about 60 mm to about 70 mm, about 65 mm to about 75 mm, and about 70 mm to about 79 mm, and combinations thereof.

8. The apparatus of claim 1, wherein said second layer comprising said adhesive has a thickness occurring in a range of about 0.01 mm to about 0.05 mm.

9. The apparatus of claim 8, wherein said second layer comprising said adhesive has a thickness selected from the group consisting of: about 0.02 mm to about 0.03 mm, about 0.025 mm to about 0.035 mm, about 0.030 mm to about 0.040 mm, and about 0.035 mm to about 0.045 mm, or combinations thereof.

10. The apparatus of claim 1, wherein said third layer comprising stainless steel has a thickness occurring in a range of about 0.05 mm to about 0.10 mm.

11. The apparatus of claim 10, wherein said third layer comprising stainless steel has a thickness selected from the group consisting of: about 0.04 mm to about 0.06 mm, about 0.05 mm to about 0.07 mm, about 0.06 mm to about 0.08 mm, about 0.07 mm to about 0.09 mm, and about 0.08 mm to about 0.095 mm, and combinations thereof.

12. The apparatus of claim 1, wherein said fourth layer comprising said adhesive has a thickness occurring in a range of about 0.01 mm to about 0.05 mm.

13. The apparatus of claim 12, wherein said fourth layer comprising said adhesive has a thickness selected from the group consisting of: about 0.02 mm to about 0.03 mm, about 0.025 mm to about 0.035 mm, about 0.03 mm to about 0.04 mm, and about 0.035 mm to about 0.045 mm, or combinations thereof.

14. The apparatus of any one of claim 8, wherein said second and fourth layers comprising said adhesive selected from the group consisting of: a two-sided tape, a one sided tape, latex-based adhesive, synthetic elastomeric polymer adhesive, and polyvinyl acetate adhesive, and combinations thereof.

15. The apparatus of claim 1, wherein said body wound in rolls.

16. The apparatus of claim 1, further comprising a coat composition applied over said body adhered to a surface by engaging said fourth layer comprising said adhesive to said surface.

17. The apparatus of claim 16, wherein said coat composition comprises a paint composition.

18. The apparatus of claim 16, wherein said surface comprises a drywall surface and wherein said coat composition comprises a drywall surface primer.

19-39. (canceled)

40. The apparatus of any one of claim 12, wherein said second and fourth layers comprising said adhesive selected from the group consisting of: a two-sided tape, a one sided tape, latex-based adhesive, synthetic elastomeric polymer adhesive, and polyvinyl acetate adhesive, and combinations thereof.
